(19) United States
(12) Patent Application Publication
(10) Pub. No.: US 2003/0220988 A1
(43) Pub. Date: Nov. 27, 2003

(54) Method and electronic device for establishing an interface to control an accessory device

(76) Inventor: James A. Hymel, Lake Worth, FL (US)

Correspondence Address: MARSHALL, GERSTEIN & BORUN (MOTOROLA), 233 SOUTH WACKER DRIVE, SUITE 6300, CHICAGO, IL, 60606-6402, US

(21) Appl. No.: 10/153,503

(22) Filed: May 22, 2002

(51) Int. Cl. G06F 15/177; G06F 13/10

(52) U.S. Cl. 709/220; 709/321

(57) ABSTRACT

A method (400) and an electronic device (110) for establishing an interface to control an accessory device (120) are described herein. The electronic device (110) is in communication with the accessory device (120) via a communication link (150). The electronic device (110) may detect the accessory device (120). Upon detection of the accessory device (120), the electronic device (110) may receive device information from the accessory device (120) via the communication link (150). The device information is associated with the accessory device (120), which may include a type identifier, a sequence identifier, and an Internet link. The electronic device (110) may retrieve a device driver from the Internet link based on the device information. The device driver includes information for the electronic device (110) to control the accessory device (120).

### TECHNICAL FIELD

The present disclosure relates to communication systems, and more particularly, to a method and an electronic device for establishing an interface to control an accessory device.

### BACKGROUND

Typically, a user may connect a variety of accessory devices (i.e., peripherals and add-on devices) to an electronic device such as a laptop computer, a cellular telephone, a personal digital assistant (PDA), and a video game console to perform many different functions (i.e., “plug-and-play”). For example, a keyboard may be connected to a cellular telephone for inputting telephone numbers and/or text messages for transmission. Another example may be a printer being connected to a PDA to generate a hard copy of an e-mail and/or a file. Other examples of an accessory device that may be connected to an electronic device include a mouse, a digital camera, a digital camcorder, a compact disk (CD) player, a digital video disk (DVD) player, a scanner, a monitor, a handheld game controller (e.g., a joystick) and an MPEG (Moving Picture Experts Group) Audio Layer-3 (MP3) player. Nonetheless, in any case, a user may not be able to use an electronic device to control an accessory device by simply connecting the devices together.

To control the accessory device, the electronic device may need a device driver (i.e., a program or a protocol). That is, the electronic device may install the device driver to convert input/output instructions from the electronic device into messages that the accessory device can understand. Typically, when the accessory device is connected, the electronic device determines whether the device driver for controlling the accessory device is pre-stored in a local memory of the electronic device. For example, the device driver may be stored in the local memory by the manufacturer of the electronic device. If the device driver is pre-stored in the local memory, the electronic device may either automatically install the device driver or query the user whether to install the device driver to control the accessory device. However, if the device driver is not found the local memory, the electronic device may require the user to manually install the device driver. Accordingly, most accessory devices may come with a disk such as a floppy disk and a CD-ROM disk that stores the device driver for the accessory device. For example, the device driver for a new type of accessory device and/or new version of an accessory device may be stored on a disk because the manufacturer of an electronic device may not have anticipated for the new accessory device to store the device driver in the local memory of the electronic device. However, not all electronic devices (e.g., a cellular telephone or a PDA) may have a disk drive for the user to insert a disk and install the device driver from the disk. Alternatively, the user may be able to retrieve the device driver from the Internet. For example, the user may access the website of the manufacturer for the accessory device to download the device driver. Even so, the user may still be required to determine the appropriate device driver for the accessory device and manually install the device driver onto the electronic device.

One aspect of designing an electronic device is to maximize convenience for the user. In particular, the user should be able to easily set up an electronic device to control an accessory device. Therefore, a need exist for an electronic device to establish an interface to control an accessory device with minimal effort from the user.

### BRIEF DESCRIPTION OF THE DRAWINGS

This disclosure will be described in terms of several embodiments to illustrate its broad teachings. Reference is also made to the attached drawings.

FIG. 1 is a block diagram representation of a communication system.

FIG. 2 is a block diagram representation of a personal access network (PAN).

FIG. 3 is a block diagram representation of an electronic device.

FIG. 4 is a flow diagram illustrating a method for establishing an interface to control an accessory device.

### DETAILED DESCRIPTION

A method and an electronic device for establishing an interface to control an accessory device are described herein. In a communication system, an electronic device may detect an accessory device, which is in communication with the electronic device via a communication link. For example, the electronic device may detect the accessory device in accordance with a connection protocol such as, but not limited to, a parallel connection protocol, an RS-232C protocol, a Small Computer System Interface (SCSI) protocol, an universal serial bus (USB) protocol, an Institute of Electrical and Electronics Engineer (IEEE) based connection protocol (e.g., IEEE 1394 high performance serial bus protocol), and an Infrared Data Association (IrDA) based connection protocol. The electronic device may be, but is not limited to, a cellular telephone, a personal digital assistant (PDA), a pager, a laptop computer, and a video game console. The accessory device may be, but is not limited to, a keyboard, a mouse, a printer, a monitor, a scanner, a speaker, an audio player (e.g., an MP3 player), a compact disk (CD) player, a digital camera, a digital camcorder, a digital video disk (DVD) player, and a handheld game controller (e.g., a joystick). The communication link may be a wired link in which the accessory device is operatively coupled to a communication port associated with the electronic device such as a parallel port, a serial port, and an universal serial bus (USB) port. The communication link may also be a wireless link such as an infrared link and a radio link between the electronic device and the accessory device. In particular, the radio link may operate in accordance with a wireless communication protocol such as a Bluetooth communication protocol and an Institute of Electrical and Electronics Engineer (IEEE) 802.11 communication protocol (e.g., IEEE 802.11b). Upon detection of the accessory device, the electronic device receives device information from the accessory device via the communication link as described above. That is, the electronic device may automatically receive device information from the accessory device. Alternatively, the electronic device may query the accessory device for device information. The device information may include, but is not limited to, a type identifier, a sequence identifier, and an Internet link associated with the accessory device. The type identifier and the sequence identifier may be, but are not limited to, a numeric code and an alphanumeric code associated with the accessory device. For example, the type identifier may be a four-bit decimal code and the sequence identifier may be an eight-bit decimal code. Based on the device information, the electronic device retrieves a device driver from the Internet link. That is, the electronic device connects to the Internet and downloads the device driver from the Internet link. The device driver includes information for the electronic device to control the accessory device. To retrieve a more specific device driver, the electronic device may modify the Internet link to include device information associated with the electronic device. Upon retrieval of the device driver, the electronic device installs the device driver to control the accessory device. As a result, a user may use the electronic device to operate the accessory device.

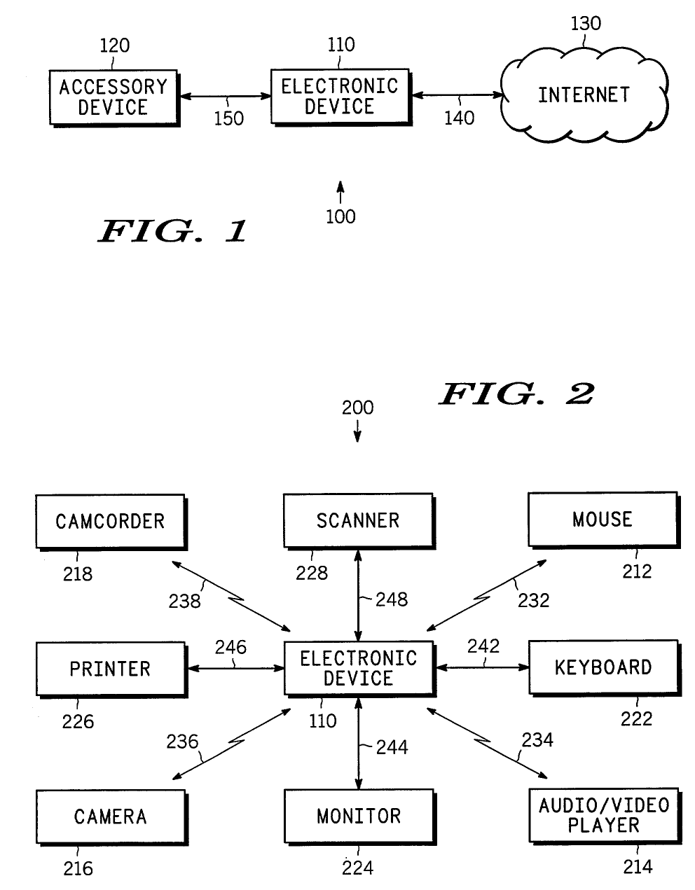

Referring to FIG. 1, a communication system 100 generally includes an electronic device 110, an accessory device 120, and the Internet 130. As used herein “Internet” refers to a worldwide system of computer networks (i.e., a network of networks). Although the embodiments disclosed herein are particularly well suited for use with devices such as a cellular telephone and a personal digital assistant (PDA), persons of ordinary skill in the art will readily appreciate that the teachings herein are in no way limited to those devices. On the contrary, persons of ordinary skill in the art will readily appreciate that the teachings can be employed with any electronic device such as a laptop computer, a pager, and a video game console.

As explained in detail below, the electronic device 110 is in communication with the Internet 130 via a first communication link 140, which may be a wired link and/or a wireless link to retrieve a device driver for controlling the accessory device 120. Persons of ordinary skill in the art will appreciate that access to the Internet may be implemented in many ways. For example, the electronic device 110 may be a laptop computer with a wireless link to an access point for a local area network (LAN) which, in turn, is operatively coupled to the Internet 130 (e.g., via a high speed connection). The wireless link may be a radio link operating in accordance with a wireless communication protocol such as, but not limited to, a Bluetooth communication protocol and an Institute of Electrical and Electronics Engineer (IEEE) 802.11 based communication protocol (e.g., IEEE 802.11b), for the electronic device 110 to communicate with the access point. Alternatively, the electronic device 110 may access the Internet 130 through a wired link provided by a conventional dial-up modem, a cable modem, an integrated services digital network (ISDN), or a digital subscriber line (DSL). In another example, the electronic device 110 may be a cellular telephone operating in accordance with a wireless communication protocol (e.g., a cellular communication protocol such as a code division multiple access (CDMA) based communication protocol, a time division multiple access (TDMA) based communication protocol, and a global system for mobile communication (GSM) based communication protocol) to communicate with an Internet service provider (ISP) for accessing the Internet 130.

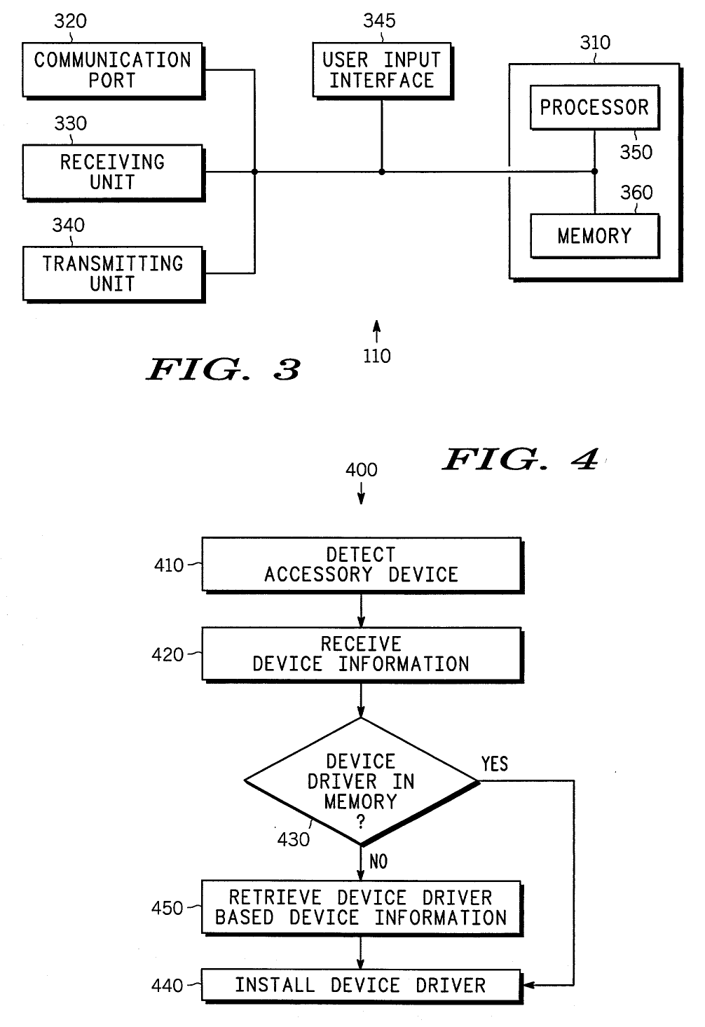

The electronic device 110 is also in communication with the accessory device 120. In a personal access network (PAN) 200 as shown in FIG. 2, the accessory device 120 may be a variety of devices in communication with the electronic device 110 via the second communication link 150. For example, the accessory device 120 may be, but is not limited to, a mouse 212, an audio and/or video player 214 (e.g., an MP3 player, a compact disk (CD) player, and a digital video disk (DVD) player), a digital camera 216, a scanner 218, a keyboard, 222, a monitor 224, a printer 226, and a scanner 228. Persons of ordinary skill in the art will readily appreciate that the accessory device 120 may be in communication with the electronic device 110 in many ways. That is, the second communication link 150 may be a wireless link, generally shown as 232, 234, 236, and 238. For example, the electronic device 110 may be in communication with a mouse 212 via the wireless link 232. The wireless link 232 may be, but is not limited to, an infrared link and a radio link. To communicate via a radio link, the electronic device 110 may operate in accordance with a wireless communication protocol such as, but not limited to, the Bluetooth communication protocol and the IEEE 802.11b communication protocol. The communication link 140 may also be a wired link, generally shown as 242, 244, 246, and 248. For example, the electronic device 110 may be operatively coupled to the monitor 224 via a wired link 244. In particular, the monitor 224 may be physically coupled to a communication port (shown in FIG. 3) such as a serial port of the electronic device 110. Persons of ordinary skill in the art will readily appreciate that the accessory device 120 may also be in communication with the electronic device 110 in many other ways.

Referring to FIG. 3, an electronic device 110 adapted to establish an interface to control an accessory device 120 is shown. The electronic device 110 generally includes a controller 310, a communication port 320, a receiving unit 330, a transmitting unit 340, and a user input interface 345. The controller 310 includes a processor 350 and a memory 360. The processor 350 is operatively coupled to the memory 360, which stores a program or a set of operating instructions for the processor 350. The processor 350 executes the program or the set of operating instructions such that the electronic device 110 operates as described herein. The program or the set of operating instructions may be embodied in a computer-readable medium such as, but not limited to, paper, a programmable gate array, an application specific integrated circuit (ASIC), an erasable programmable read only memory (EPROM), a read only memory (ROM), a random access memory (RAM), a magnetic media, and an optical media.

As noted above, the electronic device 110 is in communication with the accessory device 120 via the communication link 150. For example, the accessory device 120 may be operatively coupled to the communication port 320 to establish a wired communication link between the electronic device 110 and the accessory device 120. The communication port 320 may be, but is not limited to, a parallel port, a serial port, and a universal serial bus (USB) port. Alternatively, the electronic device 110 may be in communication with the accessory device 120 via a wireless communication link (e.g., an infrared link or a radio link). In accordance with a wireless communication protocol such as the Bluetooth communication protocol, the receiving unit 330 and the transmitting unit 340 may provide a radio link between the wireless device 110 and the accessory device 120. Persons of ordinary skill in the art will readily appreciate that the receiving unit 330 and the transmitting unit 340 may be separate components or integrated into a single component, e.g., a transceiver unit. Further, the receiving unit 330 and the transmitting unit 340 may operate in accordance with other wireless communication protocols such as the IEEE 802.11b communication protocol to communicate with the accessory device 120.

A basic flow for establishing an interface to control an accessory device that may be applied with the electronic device shown in FIG. 3 may start with the controller 310 detecting the accessory device 120. Persons of ordinary skill in the art will readily appreciate that the controller 310 may detect the accessory device 120 in many ways. For example, the controller 310 may detect the accessory device 120 in accordance with a connection protocol (i.e., a plug-and-play standard) such as, but not limited to, a parallel connection protocol, an RS-232C protocol, a Small Computer System Interface (SCSI) protocol, an USB protocol, an IEEE based connection protocol (e.g., IEEE 1394 high performance serial bus protocol), and an IrDA based connection protocol. Alternatively, the electronic device 110 may also transmit an inquiry signal (e.g., via the transmitting unit 340) in accordance with a radio communication protocol such as the Bluetooth communication protocol to detect the accessory device 120. In response to the inquiry signal, the accessory device 120 may transmit a response signal to electronic device 110 to indicate that the accessory device 120 is in communication with the electronic device 110. Thus, the electronic device 110 may detect the accessory device 120.

Upon detecting the accessory device 120, the controller 310 may receive device information from the accessory device 120 via the communication link as described above. For example, the controller 310 may automatically receive device information from the accessory device 120 upon detection of the accessory device 120. The controller 310 may also query the accessory device 120 for device information after detecting the accessory device 120. The device information may include, but is not limited to, a type identifier, a sequence identifier, and an Internet link. Based on the accessory information, the controller 310 retrieves a device driver associated with the accessory device 120. The device driver may be, but is not limited to, a program or a set of operating instructions that allows the electronic device 110 to control the accessory device 120 (i.e., the device driver converts input/output instructions from the electronic device into messages that the accessory device can understand). To illustrate the concept of retrieving the device driver based on the device information, the controller 310 may use the type identifier to determine the type of device of the accessory device 120. The type identifier may be, but is not limited to, a numeric code and an alphanumeric code associated with the type of device of the accessory device 120. That is, the type identifier may be, but is not limited to, a binary code, a decimal code, and a hexadecimal code. For example, the type identifier may be a four-bit decimal code with 0001 identifying an MPEG (Moving Picture Experts Group) Audio Layer-3 (MP3) player, 0002 identifying a keyboard, and 0003 identifying a digital camera. Further, the controller 310 may use the sequence identifier to determine the version and the manufacturer of the accessory device 120. Similar to the type identifier, the sequence identifier may be, but is not limited to, a numeric code and an alphanumeric code associated with the version and the manufacturer of the accessory device 120. For example, the sequence identifier may be an eight-bit decimal code with the first four bits identifying the manufacturer of the accessory device and the second four bits identifying the version of the accessory device. In particular, a sequence identifier of 0000 0001, a sequence identifier of 0000 0002, and a sequence identifier 0000 0003 may identify the first, second, and third versions of a particular device from a particular manufacturer. To further distinguish the accessory device 120, the controller 310 may use the sequence identifier to determine the manufacturer. That is, a sequence identifier of 0000 0001 may identify that the accessory device is a Motorola product and a first version of that product whereas a sequence identifier 0001 0001 may identify that the accessory device is a first version but a product of another company. Based on the type identifier and the sequence identifier, the controller 310 may determine whether the device driver associated with the accessory device 120 is stored in the memory 360. If the device driver is not found in the memory 360, the controller 310 may automatically access the Internet 130 to retrieve the device driver from the Internet link where the device driver is stored (i.e., the Internet link included in the device information provided by the accessory device 120). Alternatively, the controller 310 may query the user whether to retrieve the device driver from the Internet link. In response to an input via the user input interface 345 to retrieve and install the device driver, the controller 310 may access the Internet and download the device driver from the Internet link.

The Internet link may be, but is not limited to, an uniform resource locator (URL) link and an Internet protocol (IP) address. In particular, the URL link may include, but not is limited to, an Internet protocol (e.g., hyper text transfer protocol (“http”) or file transfer protocol (“ftp”)), a server name, and a file name. The server name may be based on, but not limited to, the sequence identifier. For example, the sequence identifier may identify that the manufacturer of the accessory device 120 is Motorola, Inc. Accordingly, the server name may be “www.motorola.com.” The file name may be based on, but not limited to, the type identifier and the sequence identifier. To illustrate this concept, the type identifier may be 0002, which corresponds to a keyboard manufactured by Motorola, and the sequence identifier may be 0000 0003, which corresponds to the third version of the keyboard. As a result, the file name may be “keyboards/00000003.htm.” Accordingly, the URL link may be “http://www.motorola.com/keyboards/00000003.htm,” which is, for example, where the controller 310 may download the device driver for the third version of a Motorola keyboard. The controller 310 may also include device information associated with the electronic device 110 into the URL link to retrieve the device driver associated with the accessory device 120. That is, the controller 310 may provide a type identifier and a sequence identifier of the electronic device 110. For example, the device type identifier for a Motorola cellular telephone may be 0001, and the device sequence identifier for a second version may be 0000 0002. As a result, the controller 310 may connect to the following URL link to download the device driver for the second version of a Motorola cellular telephone (i.e., the electronic device 110) to control the third version of a Motorola keyboard (i.e., the accessory device 120): “http://www.motorola.com/keyboards/00000003/0001/00000002.htm.” Upon retrieval of the device driver, the controller 310 may install the device driver onto the electronic device 110 to establish an interface to control the accessory device 120. As a result, the user may operate the accessory device 120 via the electronic device 110.

One possible implementation of the computer program executed by the electronic device 110 (e.g., via the processor 350) to provide the environments reflected in FIGS. 1 and 2 is illustrated in FIG. 4. Persons of ordinary skill in the art will appreciate that the computer program can be implemented in any of many different ways utilizing any of many different programming codes stored on any of many computer-readable mediums such as a volatile or nonvolatile memory or other mass storage device (e.g., a floppy disk, a compact disc (CD), and a digital versatile disc (DVD)). Thus, although a particular order of steps is illustrated in FIG. 4, persons of ordinary skill in the art will appreciate that these steps can be performed in other temporal sequences. Again, the flow chart 400 is merely provided as an example of one way to program the electronic device 110 to establish an interface to control an accessory device. The flow chart 400 begins at step 410, wherein the electronic device 110 detects the accessory device. For example, the electronic device 110 may detect the accessory device in accordance with a connection protocol such as the USB protocol. At step 420, the electronic device 110 receives device information associated with the accessory device. For example, the device information may include, but is not limited to, a type identifier, a sequence identifier, and an Internet link. Based on the device information, the electronic device 110 at step 430 determines whether a device driver is stored in the electronic device 110 (e.g., stored in a local memory of the electronic device 110). If the device driver is stored in the electronic device 110, the device driver may be installed at step 440 so that the electronic device 110 may establish an interface to control the accessory device. However, if the device driver is not found, the electronic device 110 may access the Internet to connect to the Internet link provided by the accessory device. Alternatively, the electronic device 110 may modify the Internet link to include a type identifier and a sequence identifier associated with the electronic device. As a result, the electronic device 110 may be able to find the device driver quicker and/or a version of the device driver that is specified for the electronic device 110. At step 450, the electronic device 110 may download the device driver for the accessory device from the Internet link. Upon retrieval of the device driver, the electronic device 110 at step 440 may install the device driver to establish an interface to control the accessory device. As a result, the electronic device 110 may control the accessory device.

Many changes and modifications to the embodiments described herein could be made. The scope of some changes is discussed above. The scope of others will become apparent from the appended claims.

What is claimed is:

1. In a communication system including a primary device is in communication with a secondary device via a communication link, a method to establish an interface to control the secondary device, the method comprising:
detecting the secondary device;
receiving device information from the secondary device via the communication link, the device information being associated with the secondary device; and
retrieving a device driver from an Internet link based on the device information associated with the secondary device, the device driver having information for the primary device to control the secondary device.

2. The method of claim 1, wherein the step of detecting the accessory device comprises detecting the accessory device in accordance with a connection protocol.

3. The method of claim 1, wherein the step of receiving device information from the secondary device via the communication link comprises receiving device information from the secondary device via one of a wired link and a wireless link, the wireless link being one of an infrared link and a radio link.

4. The method of claim 1, wherein the step of receiving device information from the secondary device via the communication link comprises receiving one of a type identifier, a sequence identifier, and an Internet link associated with the secondary device.

5. The method of claim 1, wherein the step of receiving device information from the secondary device via the communication link comprises receiving one of a numeric code and an alphanumeric code associated with one of the type, the version, and the manufacturer of the secondary device.

6. The method of claim 1, wherein the step of receiving device information from the secondary device via the communication link comprises receiving device information associated with one of a keyboard, a mouse, a printer, a monitor, a scanner, a speaker, an audio player, a compact disk (CD) player, a digital camera, a digital camcorder, a digital video disk (DVD) player, and a handheld game controller via the communication link.

7. The method of claim 1, wherein the step of retrieving a device driver from an internet link based on the device information associated with the secondary device comprises downloading a device driver from one of an uniform resource locator (URL) link and an Internet Protocol (IP) address.

8. The method of claim 1, wherein the step of retrieving a device driver from an Internet link based on the device information associated with the secondary device comprises:
modifying the Internet link with device information associated with the primary device to produce a modified Internet link; and
downloading a device driver from the modified Internet link.

9. The method of claim 1, wherein the step of retrieving a device driver from an Internet link based on the device information associated with the secondary device comprises:
operating in accordance with a wireless communication protocol to access the Internet, the wireless communication protocol being one of a code division multiple access (CDMA) based communication protocol, a time division multiple access (TDMA) based communication protocol, and a global system for mobile communication (GSM) based communication protocol; and
downloading a device driver from the Internet link.

10. The method of claim 1, wherein the primary device is one of a cellular telephone, a personal digital assistant (PDA), a pager, a laptop computer, and a video game console.

11. A method for operating an accessory device, the method comprising:
providing a first communication link to the accessory device;
detecting the accessory device;
receiving accessory information associated with the accessory device via the first communication link;
providing a second communication link to a network;
receiving a program based on the accessory information via the second communication link; and
installing the program to control the accessory device.

12. The method of claim 11, wherein the step of receiving accessory information associated with the accessory device via the first communication link comprises receiving accessory information associated with the accessory device via one of a wired link and a wireless link.

13. The method of claim 11, wherein the step of receiving accessory information associated with the accessory device via the first communication link comprises receiving one of an accessory type identifier, an accessory sequence identifier, and an Internet link associated with the accessory device via the first communication link.

14. The method of claim 11, wherein the step of receiving accessory information associated with the accessory device via the first communication link comprises receiving one of a numeric code and an alphanumeric code associated with one of the type, the version, and the manufacturer of the accessory device.

15. The method of claim 11, wherein the step of receiving accessory information associated with the accessory device via the first communication link comprises receiving accessory information associated with one of a keyboard, a mouse, a printer, a monitor, a scanner, a speaker, an audio player, a compact disk (CD) player, a digital camera, a digital camcorder, a digital video disk (DVD) player, and a handheld game controller via the first communication link.

16. The method of claim 11, wherein the step of receiving a program based on the accessory information via the second communication link comprises receiving a program based on the accessory information via a communication link to one of an uniform resource locator (URL) and an Internet Protocol (IP) address.

17. The method of claim 11, wherein the step of receiving a program based on the accessory information via the second communication link comprises receiving a program based on the accessory information via one of a wired link and a wireless link.

18. An electronic device for establishing an interface to control an accessory device, the electronic device comprising:
a communication unit operable to provide a communication link between the electronic device and an accessory device; and
a controller operatively coupled to the communication unit, the controller comprising a processor and a memory operatively coupled to the processor,
the controller being programmed to detect the accessory device;
the controller being programmed to receive accessory information from the accessory device via the communication unit, the accessory information being associated with the accessory device, and
the controller being programmed to retrieve a device driver from an Internet link based on the accessory information, the device driver having information for the electronic device to control the accessory device.

19. The electronic device of claim 18, wherein the communication unit is one of a receiving unit and a transmitting unit.

20. The electronic device of claim 18, wherein the communication unit is one of a parallel port, a serial port, an universal serial bus (USB) port, an infrared port, and a radio port.

21. The electronic device of claim 18, wherein the communication link is one of a wired link and a wireless link.

22. The electronic device of claim 18, wherein the accessory information comprises one of an accessory identifier, an accessory sequence identifier, and an Internet link.

23. The electronic device of claim 18, wherein the accessory information comprises one of a numeric code and an alphanumeric code associated with one of the type, the version, and the manufacturer of the accessory device.

24. The electronic device of claim 18, wherein the accessory device is one of a keyboard, a mouse, a printer, a monitor, a scanner, a speaker, an audio player, a compact disk (CD) player, a digital camera, a digital camcorder, a digital video disk (DVD) player, and a handheld game controller.

25. The electronic device of claim 18, wherein the Internet link is one of an uniform resource locator (URL) link and an Internet Protocol (IP) address.

26. The electronic device of claim 18, wherein the Internet link is based on device information associated with the electronic device and the accessory device.

27. The electronic device of claim 18 is one of cellular telephone, a personal digital assistant (PDA), a pager, a laptop computer, and a video game console.

28. In a communication system, wherein a primary device is in communication with a secondary device via a communication link, wherein a processor operates in accordance with a computer program embodied on a computer-readable medium for establishing an interface to control the secondary device, the computer program comprising:
a first routine that directs the processor to detect the accessory device;
a second routine that directs the processor to receive device information from the secondary device via the communication link, the device information being associated with the secondary device;
a third routine that directs the processor to retrieve a device driver from an Internet link based on the device information associated with the secondary device, the device driver having information for the primary device to control the secondary device.

29. The computer program of claim 28, wherein the second routine comprises a routine that directs the processor to receive device information from the secondary device via one of a wired link and a wireless link, the wireless link being one of an infrared link and a radio link.

30. The computer program of claim 28, wherein the second routine comprises a routine that directs the processor to receive one of a type identifier, a sequence identifier, and an Internet link associated with the secondary device.

31. The computer program of claim 28, wherein the second routine comprises a routine that directs the processor to receive one of a numeric code and an alphanumeric code associated with one of the type, the version, and the manufacturer of the secondary device.

32. The computer program of claim 28, wherein the second routine comprises a routine that directs the processor to receive device information associated with one of a keyboard, a mouse, a printer, a monitor, a scanner, a speaker, an audio player, a compact disk (CD) player, a digital camera, a digital camcorder, a digital video disk (DVD) player, and a handheld game controller via the communication link.

33. The computer program of claim 28, wherein the third routine comprises a routine that directs the processor to download a device driver from one of an uniform resource locator (URL) link and an Internet Protocol (IP) address.

34. The computer program of claim 28, wherein the third routine comprises a routine that directs the processor to modify the Internet link with device information associated with the primary device to produce a modified Internet link, and a routine that directs the processor to download a device driver from the modified Internet link.

35. The computer program of claim 28, wherein the third routine comprises a routine that directs the processor to operate in accordance with a wireless communication protocol to access the Internet, and a routine that directs the processor to download a device driver from the Internet link.

36. The computer program of claim 28, wherein the primary device is one of a cellular telephone, a personal digital assistant (PDA), a pager, a laptop computer, and a video game console.

37. The computer program of claim 28, wherein the medium is one of paper, a programmable gate array, application specific integrated circuit, erasable programmable read only memory, read only memory, random access memory, magnetic media, and optical media.
